(19) United States
(12) Patent Application Publication
(10) Pub. No.: US 2004/0131445 A1
(43) Pub. Date: Jul. 8, 2004

(54) Nut, a fastener provided with a nut, and a fastening device therefor

(76) Inventor: Carl Kjellberg, Mahwah, NJ (US)

Correspondence Address: Striker, Striker & Stenby, 103 East Neck Road, Huntington, NY, 11743, US

(21) Appl. No.: 10/337,170

(22) Filed: Jan. 6, 2003

(51) Int. Cl. F16B 33/00

(52) U.S. Cl. 411/368

(57) ABSTRACT

A nut arranged on a bolt has a first portion spaced in an axial direction from a washer and having a polygonal outer surface, and a second portion located between the first portion and the washer and having a transverse dimension which is smaller than a transverse dimension of the polygonal surface of the first portion of the nut, wherein a holding engages with the washer so as to hold the washer and to prevent it from turning, and a driving element engages with the polygonal surface of the nut and to turn the nut.

### BACKGROUND OF THE INVENTION

The present invention relates to a nut, a fastener provided with a nut, and a fastening device therefor.

In order to tighten the fastener, a holding element of a tightening tool can hold the washer engaged with the bolt to prevent turning of the washer, while the turning element of the tool turns the nut. This is disclosed for example in patent application Ser. Nos. 10/010,377 and 10/120,343. In this construction it is not possible to use a regular hexagonal nut, since the washer is of the same size it would be impossible to place the driving element formed as an inner socket on the nut and the holding element formed as an outer socket of the washer. This is because the outer socket could not be taken off when the nut is tight simply since the hexagonal surface of the nut might not be aligned with the hexagonal surface of the washer. It is not desirable to increase the transverse cross-section of the hexagonal surface of the washer because side-clearance problems can be encountered due to the larger diameter of the holding element formed as the outer socket.

### SUMMARY OF THE INVENTION

Accordingly, it is an object of the present invention to provide a nut, a fastener provided with a nut, and a fastening device therefor, which avoid the disadvantages of the prior art.

In keeping with these objects and with others which will become apparent hereinafter, one feature of the present invention resides, briefly stated in a fastener which has a bolt; a nut threadingly engaging with a bolt; provided with a polygonal washer adapted to be located between the nut and an object in which the bolt is introducible and being engaged with the bolt so that the bolt is non rotatable relative to the washer but axially displaceable relative to said washer, said washer having a polygonal circumferential surface, said nut having a first portion spaced in an axial direction from said washer and having a polygonal outer surface, said and a second portion adapted to be located between said first portion and said washer and having a transverse dimension which is smaller than a transverse dimension of said polygonal surface of said first portion of said nut.

In accordance with another feature of the present invention a fastener is proposed, which has a bolt, a nut threadingly engaging with said bolt, a polygonal washer adapted to be located between said nut and an object in which said bolt is introducible engaged with said bolt so that said bolt is non rotatable relative to said washer but axially displaceable relative to said washer, said nut having a first portion spaced in an axial direction from said washer and having a polygonal outer surface, and a second portion located between said first portion and said washer and having a transverse dimension which is smaller than a transverse dimension of said polygonal surface of said first portion of said nut.

Finally, a fastening device is proposed which has a fastener including a bolt, a nut threadingly engaging with said bolt, a polygonal washer adapted to be located between said nut and an object in which said bolt is introducible and engaged with said bolt so that said bolt is non rotatable relative to said washer but axially displaceable relative to said washer said nut having a first portion spaced in an axial direction from said washer and having a polygonal outer surface, and a second portion located between said first portion and said washer and having a transverse dimension which is smaller than a transverse dimension of said polygonal surface of said first portion of said nut; and tightening means including a first element engageable with said washer so as to hold said washer and to prevent it from turning, and a turning member adapted to engage with said polygonal surface of said nut and to turn said nut.

When the inventive solution is proposed, a regular polygonal or hexagonal nut can be used to be placed on the washer with the same size of its polygonal surface, except that the bottom part of the polygonal nut has a smaller transverse cross-section, preferably is rounded off. When a polygonal socket which forms the turning element is loose inside of another polygonal socket which forms the holding element of a larger diameter and the outer socket has a height smaller than the height of the second portion of the nut, the outer socket first slips over the first polygonal portion of the nut and then can be rotated to slip on the polygonal surface of the washer, while the inner socket engages the polygonal surface of the nut.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view showing a known fastener with a bolt, a nut, and also a washer engaging the bolt to prevent their rotation relative to one another;

FIG. 2 is a view showing a fastener with a new nut in accordance with the present invention;

FIG. 3 is a view showing a fastening device with the fastener in accordance with the present invention;

FIG. 4 is a bottom view of a holding element of the fastening device in accordance with the present invention; and

FIG. 5 is a view substantially corresponding to the view of FIG. 3 but showing the position of the fastening device in which the nut and the washer are engaged correspondingly by a driving element and a holding element of a power tool.

### DESCRIPTION OF THE PREFERRED EMBODIMENTS

FIG. 1 shows a known fastener which includes a nut 1, a bolt 2, and a washer 3. The nut 1 is formed as a polygonal nut, for example a hexagonal nut, a point nut, etc., and is screwed on the bolt 2 provided with an outer thread. The washer 3 is adapted to be located between the nut 1 and an object composed for example of two parts to be connected with one another, in which object the bolt 2 is introduced. The washer 3 is connected with the bolt 2 so that the bolt 2 can not rotate relative to the washer 3, but can move axially relative to the latter. For example, an inner surface of a part of the washer 3 can be provided with a thread engageable with the thread of the bolt 2, as disclosed in the above mentioned patent applications.

A fastener in accordance with the present invention also includes a nut 1′, a bolt 2, and a washer 3. The nut however is formed in a different way. The nut 1′ includes a first portion which is identified with reference numeral 4 and is spaced from the washer 3 as considered in an axial direction, and a second portion which is identified with reference numeral 5 and is located between the first nut portion 4 and the washer 3. The first nut portion 4 has a polygonal outer surface, for example a hexagonal surface, a twelve point surface, etc. The second nut portion 5 has a transverse dimension which is smaller than the transverse dimension of the first nut portion 4. Preferably the second nut portion 5 is round.

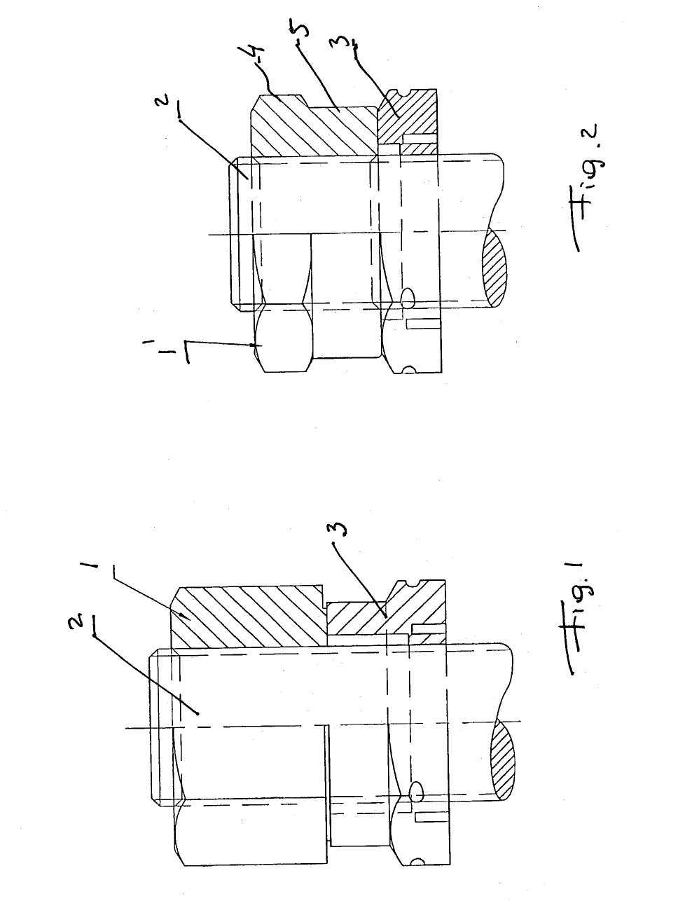

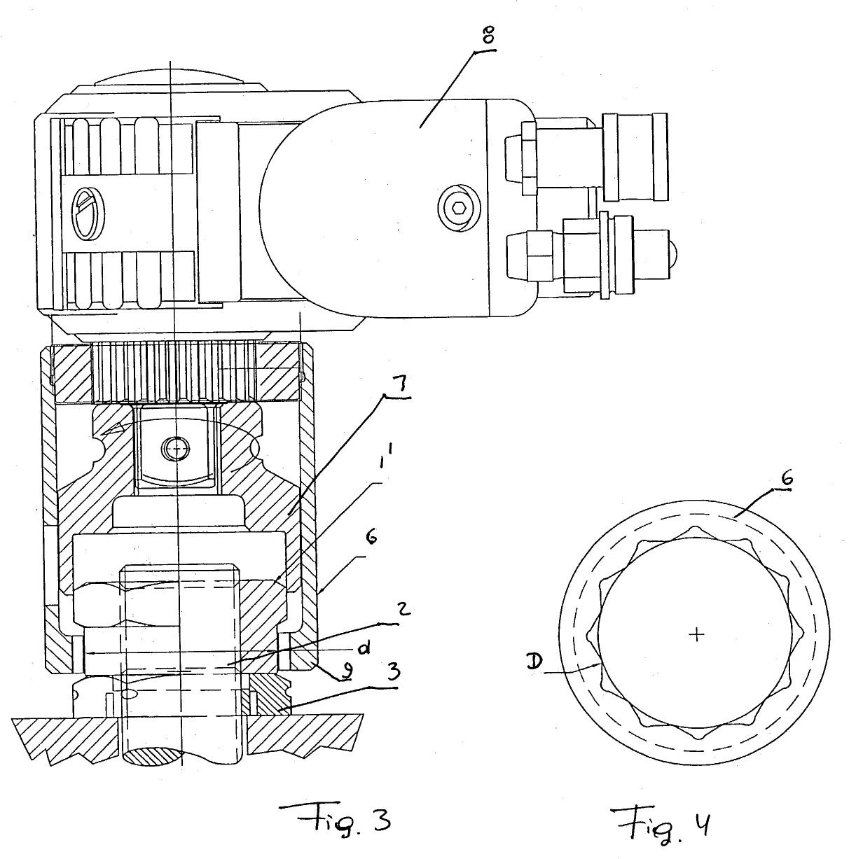

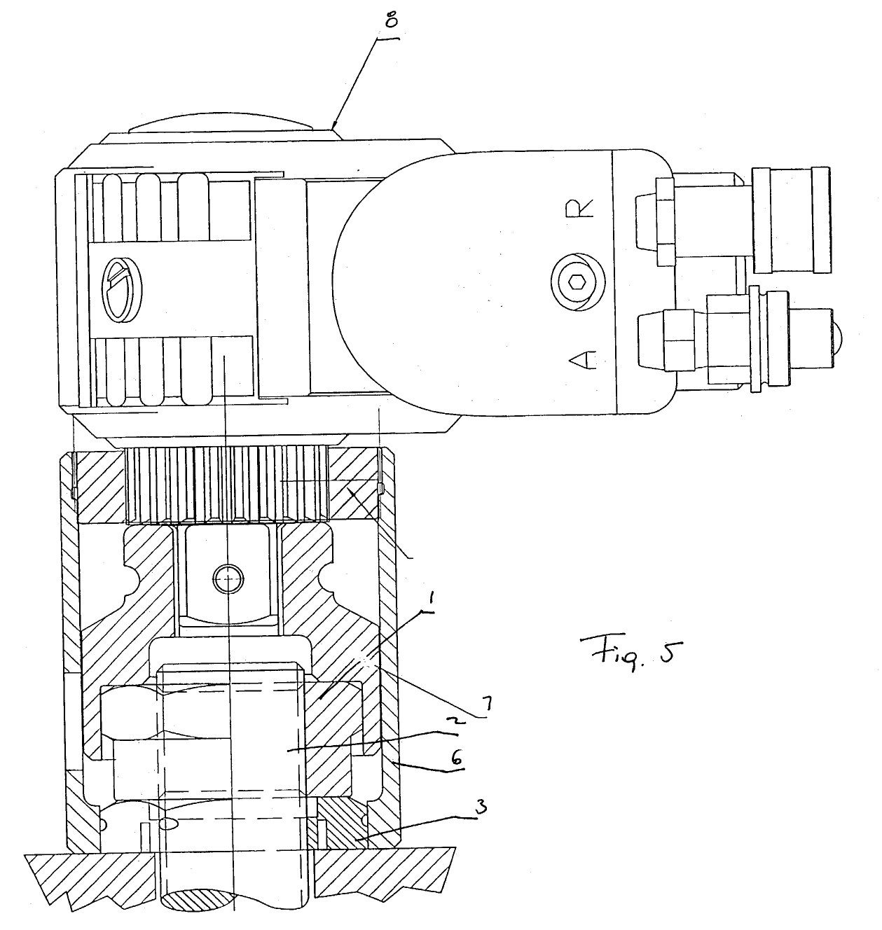

FIG. 3 shows a fastening device in accordance with the present invention. The fastening device includes a fastener comprising the nut 1′, the bolt 2 and the washer 3 shown in FIG. 2, and also tightening means. The tightening means include an outer holding element 6 and an inner driving element 7. The inner driving element 7 is connectable to a turning element of a torque tool 8, for example to a ratchet of a ratchet-lever mechanism of the torque tool 8. The outer holding element 6 is connectable through a splined adaptor 9 to a housing of the torque tool 8 to transmit a reaction torque from the holding element 6 to the housing of the torque tool. The outer holding element 6 has a holding portion which is identified as a reference numeral 9 and adapted to engage the outer polygonal surface of the washer 3. The height of the holding portion 2 of the holding element 6 in an axial direction is smaller than the height of the second nut portion 5. The outer transverse dimension of the second nut portion 5, for example its outer diameter d, is be smaller than an inner transverse dimension or an inner diameter D of the holding portion 9 of the outer holding element 6.

In operation the washer 3 is connected with the bolt 2 and the bolt 2 is introduced into an object composed for example of two parts to be connected with one another, and the nut 4 is screwed on the bolt. Then a power tool 8 is applied to the thusly formed fastener so that its inner driving element 7 engages the outer polygonal surface of the nut 1′, and its outer holding element 6 first slips over the outer polygonal surface of the nut 1′ and then its holding portion 9 can be rotated to slip onto the hexagonal outer surface of the washer 3. The inner driving element 7 is then rotated while the outer holding element 6 holds on the washer, so that the nut 1′ is tightened on the bolt 2.

It will be understood that each of the elements described above, or two or more together, may also find a useful application in other types of constructions differing from the types described above.

While the invention has been illustrated and described as embodied in a nut, fastener provided with a nut, and fastening device therefor, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A nut for a fastener including a bolt; a nut threadingly engaging with the bolt, and a polygonal washer adapted to be located between the nut and an object in which the bolt is introducible and engaged with said bolt so that the bolt is non rotatable relative to the washer but axially displaceable relative to the washer, said washer having a polygonal circumferential surface, said nut having a first portion spaced in an axial direction from said washer and having a polygonal outer surface, and a second portion adapted to be located between the first portion and said washer and having a transverse dimension which is smaller than a transverse dimension of said polygonal surface of said first portion of said nut.

2. A nut as defined in claim 1, wherein said second portion of said nut has a circular cross-section.

3. A fastener, comprising a bolt; a nut threadingly engaging with said bolt; a washer adapted to be located between said nut and an object in which said bolt is introducible and engaged with said bolt so that said bolt is non rotatable relative to said washer but axially displaceable relative to said washer, said nut having a first portion spaced in an axial direction from said washer and having a polygonal outer surface, and a second portion located between said first portion and said washer and having a transverse dimension which is smaller than a transverse dimension of said polygonal surface of said first portion of said nut.

4. A fastener as defined in claim 3, wherein said second portion of said nut has a circular cross-section.

5. A fastening device, comprising a fastener including a bolt, a nut threadingly engaging with said bolt, a polygonal washer adapted to be located between said nut and an object in which said bolt is introducible and engaged with said bolt so that said bolt is non rotatable relative to said washer but axially displaceable relative to said washer, said nut having a first portion spaced in an axial direction from said washer and having a polygonal outer surface, and a second portion located between said first portion and said washer and having a transverse dimension which is smaller than a transverse dimension of said polygonal surface of said first portion of said nut; and tightening means including a holding element engageable with said washer so as to hold said washer and to prevent it from turning, and a driving element adapted to engage with said polygonal surface of said nut and to turn said nut.

6. A fastening device as defined in claim 5, wherein said second portion of said nut has a circular cross-section.

7. A nut as defined in claim 5, wherein said holding element has a holding portion with an axial height which is smaller than an axial height of said second portion of said nut.
